(19) United States
(12) Patent Application Publication
(10) Pub. No.: US 2006/0172777 A1
(43) Pub. Date: Aug. 3, 2006

(54) Domain-driven abbreviated dialing

(76) Inventors: Mark D. Klein, Los Altos, CA (US); Douglas L. Brackbill, Aptos, CA (US); Ronald D. Stelter, San Ramon, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/338,417

(22) Filed: Jan. 23, 2006

Related U.S. Application Data
(60) Provisional application No. 60/646,661, filed on Jan. 24, 2005.

(51) Int. Cl. H04B 1/38

(52) U.S. Cl. 455/564

(57) ABSTRACT

A domain-driven abbreviated dialing method and system allow a user to dial a telephone number using an abbreviated dial string, such as for example the last M digits of a telephone number, where M is an integer less than the length of the telephone number. The abbreviated dial string is automatically resolved to a full telephone number and the number is dialed. If the user's entry cannot be unambiguously resolved, the user can be prompted to select among a limited set of candidate numbers to dial; alternatively, the system can make a “best guess”. Previous dialing behavior, known characteristics of the user, user preferences, location, domain, and/or any combination thereof can be used in order to determine which telephone number the user intends to call.

### CROSS-REFERENCE TO RELATED APPLICATIONS

This application claims priority from U.S. Provisional Application No. 60/646,661 titled “DOMAIN-DRIVEN ABBREVIATED DIALING,” filed Jan. 24, 2005, the disclosure of which is incorporated herein by reference.

This application is related to the following U.S. patent applications, the disclosures of which are incorporated herein by reference:
U.S. patent application Ser. No. 11/060,232 for CALL MANAGEMENT, filed Feb. 16, 2005 (attorney docket number 9193);
U.S. patent application Ser. No. 11/060,642 for DYNAMICALLY ROUTING TELEPHONE CALLS, filed Feb. 16, 2005 (attorney docket number 10031); and
U.S. patent application Ser. No. 11/060,085 for INFORMING CALLER OF CALLEE ACTIVITY MODE, filed Feb. 16, 2005 (attorney docket number 10032).

### FIELD OF THE INVENTION

This invention relates generally to dialing of telephone numbers, and more specifically to techniques for enabling abbreviated dialing of telephone numbers.

### BACKGROUND OF THE INVENTION

Telephone numbers are often difficult to remember and cumbersome to enter on a keypad. In the United States, telephone numbers are typically ten digits in length, including a three-digit area code and a seven-digit local number. A typical user of a telephone is tasked with memorizing telephone numbers for many people, including friends, family, business associates, and the like. Many users find it difficult to remember the telephone numbers for all of the people they call on a regular basis, let alone those numbers for people they call infrequently. The number of telephone numbers a user is capable of remembering is constrained by the user's ability to memorize large strings of digits and to associate those digit strings with individuals or other callees.

In addition, many users find the process of dialing telephone numbers time-consuming and error-prone: a mistyped digit can lead to a wrong number, an unwanted telephone charge, inconvenience to both parties, lost communication (if a voicemail message is left on the wrong person's machine), wasted time in redialing, or any combination of these.

Speed-dial buttons and in-phone directories can alleviate the problem. A user can program a frequently-used telephone number into his or her telephone, so that the user need only press one button (or a few buttons) to call the number. Many cell phones and conventional phones incorporate such features.

However, these features typically require action by the user to program the telephone number and assign it to a button or directory entry (including typing in a name associated with the telephone number). Many users do not know how to perform such programming operations, or find it burdensome to do so.

In addition, such features usually are specific to a particular telephone device: if a user programs one of his or her phones with a set of frequently-called numbers, those numbers are not available at other phones associated with that user. Accordingly, the user is forced to perform programming operations separately for all of his or her telephones. In many situations, a user may have to remember that different speed dial buttons apply for different telephones (#1 may dial the user's mother from one phone, but #4 might dial the same number from another phone).

Updating and or deleting telephone numbers from buttons or in-phone directories can be burdensome. Users who fail to regularly update all of their telephones may find that information is out-of-date on some or all of their telephone devices. A telephone number that is no longer needed (or is out-of-date) may take up space in a directory or on a speed-dial button, or can lead to wrong numbers being dialed.

Area code changes can also lead to problems, as users may fail to update their stored numbers when area codes change.

What is needed, therefore, is an improved technique that reduces the amount of information users are required to memorize in order to place telephone calls. What is further needed is a technique that allows a user to place a call without having to remember or dial an entire telephone number, and that is not subject to the limitations and problems discussed above.

### SUMMARY

According to the techniques provided herein, a domain-driven abbreviated dialing method and system are provided. The system and method of the present invention allow a user to dial a telephone number using an abbreviated dial string. This reduction in digit-string length reduces the possibility of dialing errors, and allows a user to memorize telephone numbers for a larger group of people. In addition, the techniques described herein are not subject to limitations typically associated with conventional speed-dial buttons and in-phone directories.

The user can dial the last M digits of a telephone number, where M is an integer that is less than the length of the telephone number. According to the techniques provided herein, the user's entry is automatically resolved to a full telephone number and the number is dialed. If the user's entry cannot be unambiguously resolved, the user can be prompted to select among a limited set of candidate numbers to dial; alternatively, the system can make a “best guess”. Previous dialing behavior, known characteristics of the user, user preferences, location, domain, and/or any combination thereof can be used in order to determine which telephone number the user intends to call.

The present invention thus provides a technique by which a user can place a telephone call without having to remember or dial an entire telephone number.

### BRIEF DESCRIPTION OF THE DRAWINGS

FIG. 1 is a block diagram depicting an architecture for implementing the present invention according to one embodiment.

FIG. 2 is a block diagram depicting an architecture for implementing the present invention according to a second embodiment.

FIG. 3 is a flowchart depicting a method of initiating a telephone call according to the present invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

Definitions

For purposes of the description provided herein, the invention is described in terms of telephones and telephone calls. However, one skilled in the art will recognize that the techniques described herein can be used by any client device for initiating a telephone call or other communication. Thus, the term “telephone” and “telephone call” should be considered to encompass any type of client device and any type of communication, respectively. The device that initiates the communication need not be the device with which the user carries out the communication. Examples of client devices include, without limitation, mobile phones, PBX station phones, home telephones, computers, handheld devices, personal digital assistants, and the like. For purposes of the description provided herein, the terms “telephone” and “client device” are used interchangeably.

Telephone numbers are, for example, digit strings used to initiate calls using the Public Switched Telephone Network (PSTN) or other telephone network. In the United States, telephone numbers are typically ten digits in length (including a three-digit area code). However, the use of the term “telephone number” is not intended to be restrictive in any way, and such terminology should be considered to encompass any other sequence of digits including numeric or alphabetic characters or any combination thereof, that can be used for initiating a telephone call or other communication.

For purposes of the following description, the term “abbreviated dial string” refers to a string of characters that is shorter than the telephone number as it would be ordinarily dialed from the caller device. In one embodiment, the abbreviated dial string is the last N digits of the telephone number, or is some other string of digits that appears within the telephone number.

System Operation

According to one embodiment, the system of the present invention accepts user-entered abbreviated telephone numbers, also referred to herein as abbreviated addresses, and determines what telephone number the user is trying to call. The system utilizes domain membership to reduce or eliminate ambiguity when a user initiates a call with an abbreviated address, as described in more detail below.

In one embodiment, each user is associated with one or more domains. Telephone numbers that a user dials (or is likely to dial) are grouped into domains. This grouping can happen at any time, including upon initial use or configuration of the telephone system, or in response to user action to set up domains either explicitly or implicitly.

A domain is a set of telephone numbers with a common attribute. Examples of domains include:
The set of telephone numbers of some or all of the user's coworkers (WORK).
The set of telephone numbers of some or all of the user's family (FAMILY).
The set of telephone numbers the user has dialed N times (where N>=1). (DIALED)
The set of telephone numbers the user has received a call from N times (where N>=1). (RECEIVED)
The set of telephone numbers stored in the user's mobile phone, or other, address book. Multiple domains can be created based on common attributes. (CONTACTS, FRIENDS)
The set of telephone numbers found in one or more domains of other members of a one or more of a user's domain. (INDIRECT)

One skilled in the art will recognize that many other types of domains can be provided.

Any or all of these sets of telephone numbers can reside on the telephone itself, or in some other repository such as a cross-network dialed telephone number list. For example, if all of a user's phone outbound (or inbound) calls to one or more devices are logged in a common database, that database can be used to make disparate network elements work together and provide cross-network services, including abbreviated dialing, which make the user's experience more uniform when using any of the network elements.

A user may be associated with a domain by having a telephone number in the domain or by an explicit association with the domain. For example, a user may associate him- or herself or his or her device(s) with a domain explicitly by selecting that domain using, for example, a website. The point-of-purchase of a family plan is an example of an implicit association. Alternatively, when a user is a member of a domain, such as “Work-Company-XYZ,” the user's delivery device which is a member of the domain, could also be implicitly associated with that domain. If one of the user's devices is in a member of a domain, all of his or her devices could be implicitly associated with the domain. For purposes of this description, the term “membership” signifies that a telephone number is in the domain, and the term “association” signifies that the device uses the domain during abbreviated dialing lookups.

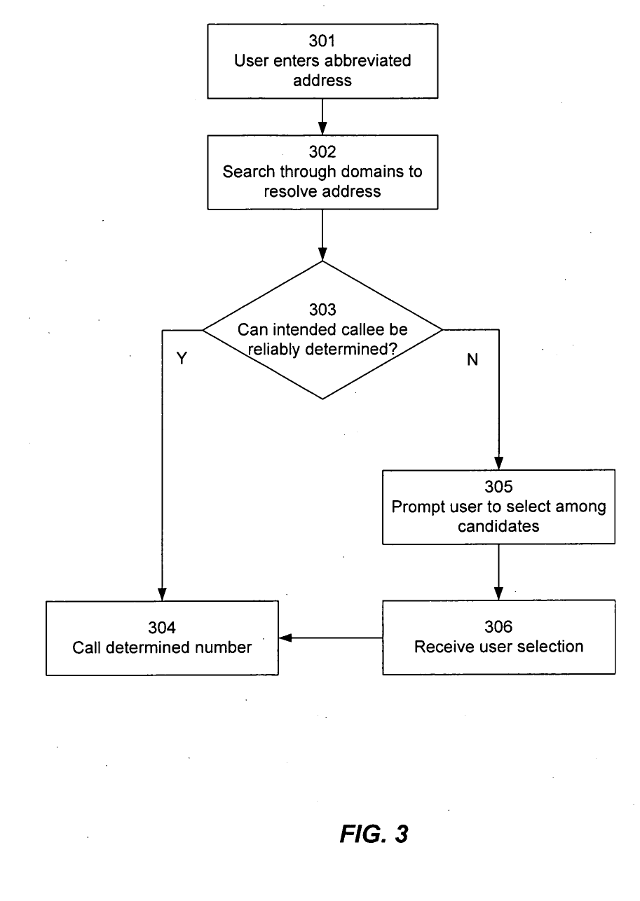

Referring now to FIG. 3, there is shown an example of a method for initiating a telephone call according to the present invention. To place a call, the user enters an abbreviated address 301. This abbreviated address is the final M digits (where M>=1) of the telephone number the user wishes to call. The user can enter the abbreviated address from memory, or can look it up in a directory.

The system uses this abbreviated address to search 302 through all of the domains associated with the user. As described above, the domains associated with the user are determined by association with the telephone number the user is calling from.

The number of digits entered as the abbreviated address is variable. In one embodiment, it is preferable to provide enough digits to reduce the ambiguity of matching telephone numbers to a small set of possible callees. In another embodiment, it is preferable to provide enough digits to eliminate ambiguity, so that the intended callee can be reliably determined from the abbreviated address.

A determination is made as to whether 303 the intended callee can be reliably determined from the abbreviated address, or whether a best guess can be made. If so, the determined number is called 304. If not, the system can prompt 305 the user to select among matching numbers. After receiving 306 the user's selection, the determined number is called 304.

System Operation

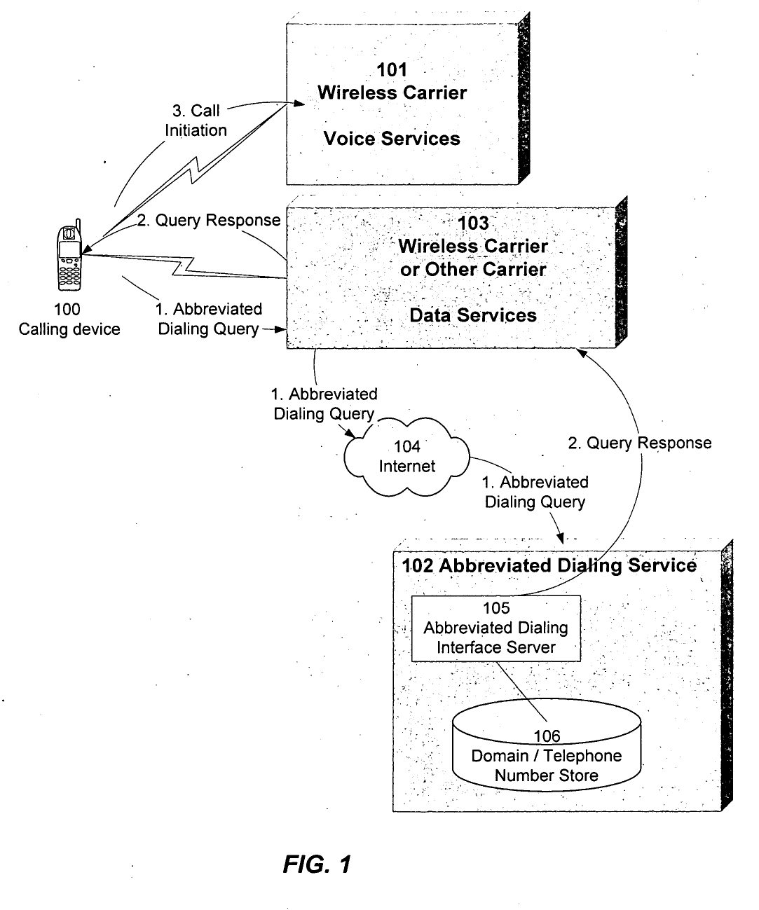

Referring now to FIG. 1, there is shown an example of an architecture for implementing the present invention according to one embodiment. Wireless carrier voice services provider 101 handles voice calls. Client device 100 queries abbreviated dialing interface server 105, located at abbreviated dialing service provider 102, to obtain the complete telephone number to be dialed. The query includes the abbreviated dial string entered by the user, along with other information that service provider 102 may use to resolve the query (such as the telephone number of client device 100). The query to server 105 can be made directly from device 100, or it can be made via data services provider 103, which may be operated by the wireless carrier or by some other carrier. Client device 100 communicates directly with abbreviated dialing service 102. Server 105 retrieves the appropriate telephone number from domain/telephone number store 106 and returns it as a query response to client device 100. In one embodiment, communications between client device 100 and service 102 (and/or between data services 103 and dialing service 102) take place over the Internet 104, including for example a wireless Internet connection.

Once client device 100 has received the telephone number from service 102, it initiates the call by communicating with wireless carrier 101 according to conventional means.

In the architecture shown in FIG. 1, the communication with abbreviated dialing service 102 is independent of the normal communication between client device 100 and wireless carrier 101. A manufacturer of client device 100 can embed functionality in device 100 to perform the query and receive information from service 102 whenever an abbreviated telephone number is dialed. Alternatively, the functionality for querying service 102 can be implemented as a software application running on client device 100, such as for example a J2ME or Microsoft Mobile application. Accordingly, the embodiment of FIG. 1 can be implemented without cooperation or permission of wireless carrier 101. This implementation is therefore advantageous when it is difficult to obtain cooperation or permission of wireless carrier 101.

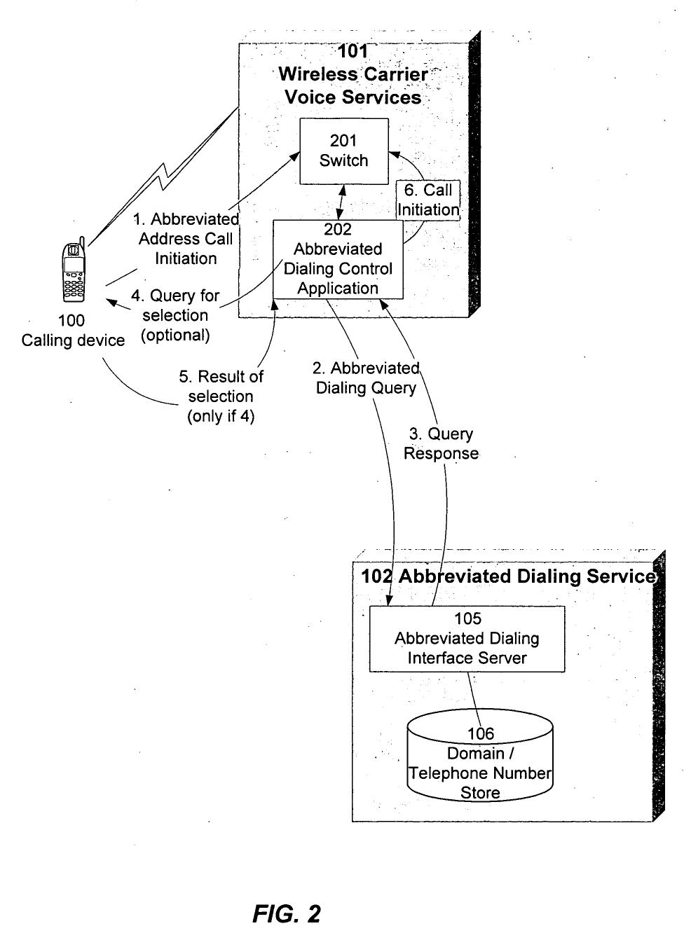

Referring now to FIG. 2, there is shown an alternative embodiment wherein wireless carrier 101 communicates with abbreviated dialing service 102 to perform the telephone number lookup. Client device 100 initiates a call by communicating with switch 201 at wireless carrier 101. Switch 101 activates abbreviated dialing control application 202, which sends an abbreviated dialing query to abbreviated dialing interface server 105 at abbreviated dialing service 102. Server 105 retrieves the appropriate telephone number(s) from domain/telephone number store 106 and returns it/them as a query response to abbreviated dialing control application 202.

If appropriate (for example if more than one candidate telephone number was returned by server 105), application 202 prompts client device 100 to present the user with an interface to select among the candidates. The user makes a selection via the input/output functionality available at client device 100, and the results of the user's selection are passed back to application 202.

Abbreviated dialing control application 202 then initiates a call via switch 201, using the selection received from client device 100 (or using the result from server 105 if a single candidate was identified).

One skilled in the art will recognize that the system architectures illustrated in FIGS. 1 and 2 are merely exemplary, and that the invention may be practiced and implemented using many other architectures and environments. For example, in one alternative embodiment, associations between abbreviated addresses and telephone numbers are stored locally at client device 100. A domain/telephone number store, similar to store 106, can be included at device 100. In such an embodiment, abbreviated addresses can be resolved locally at client device 100 itself without the need for communication with abbreviated dialing service 102 or with any other external service. Abbreviated dialing can be used to access telephone numbers stored in the mobile device address book, inbound call log, called-number log, or other local store. Such an implementation has advantages over conventional speed dial buttons in that there is no need for the user to explicitly assign or configure the abbreviated addresses.

In yet another embodiment, commonly used telephone number associations are stored locally, while less commonly used ones are stored at abbreviated dialing service 102. A caching arrangement can be implemented to manage the storage of associations at the two locations.

Search Methodology

Server 105 searches for matching telephone numbers in domains associated with the user using a search algorithm. In one embodiment, the search algorithm treats all of the user's domains with equal ranking (equivalent to a set of telephone numbers composed of the aggregation of all telephone numbers in each of the user's domains) or it may search domains in a pre-set order, looking for the first match or set of matches within a domain and then ceasing to search lower ranking domains. Some or all of the telephone numbers in some or all of the domains searched may be stored in a centralized database (domain/telephone number store 106), or they may be dynamically queried from any number of network connected databases. These databases may include public directories, shared directories, corporate directories (Outlook/Exchange or other), SIP proxy servers, corporate LDAP directories or other telephone number database stores.

In one embodiment, the search algorithm is dynamic, taking any combination of inputs such as: time of day, telephone number the user is calling from, presence, location, past user calling habits, or the like. These inputs can cause the user's domains to be searched in different orders and/or different combinations. For example, during working hours, the WORK domain would be searched before the FAMILY domain; outside of working hours, the FAMILY domain would be searched first. The search algorithm can adaptively learn who the user is most likely to call considering time of day, location, etc. It can display the few most likely choices on the telephone handset at all times. As a simple example, the five most recently dialed WORK telephone numbers would be displayed during working hours and the five most recently dialed FAMILY telephone numbers would be displayed during non-working hours.

The search produces a result. The search result is returned directly to client device 100 (if the FIG. 1 architecture is being used) or to an intermediary network device such as wireless carrier 101. The requesting device (client device 100 or intermediary network device) may place the call based on the returned result, or it may query for further information from the user before the call is placed.

Depending on the results received from server 105, any of several actions can be taken. Some possible results and actions that can be taken by the system and client device are as follows:

| Result | Action |
|---|---|
| No matching telephone | Inform the user that no call can be placed. |
| numbers found | |
| A single matching | The call can be immediately placed without |
| telephone number found | further user interaction. |
| A large set of | Ask the user to specify more digits in the |
| matching telephone | abbreviated address. |
| numbers found | |
| A small set of | Ask the user to select the full telephone |
| matching telephone | number or person (if name information is |
| numbers found | available). Upon selection, the call is placed. |

Alternatively, instead of directly dialing a matching telephone number, the matching telephone number or set of numbers can return corresponding additional contact information for each user associated with the matching telephone numbers. For example, if a user knows the abbreviated address for a person's home number but may want to call the mobile number instead. In other words, an abbreviated address may be used as the search key for an address book directory search.

Data Store

In one embodiment, domain/telephone number store 106 stores telephone numbers in reverse digit order. For rapid searching, store 106 also includes an index that is generated by pre-pending an integer domainID to the reversed digit-string telephone number. Storing reverse digits first is a form of hashing. Matching by the least significant digits uses the somewhat random assignment of telephone number final 4 digits to spread out the distribution of numbers of interest to any given user.

A telephone number is associated with each of the user's domains either by membership in that domain or by explicit association.

### EXAMPLES

Suppose the user, Joe Smith, has a client device with a telephone number of 510-555-3536. Joe has a user ID of userID-JOE. The domain ID-WORK_XYZ_CO is an integer assigned to domain named WORK_XYZ_CO, where Joe works. The domain ID-FAMILY_SMITH is an integer assigned to domain named FAMILY_SMITH, the domain Joe's family shares.

A database table in domain/telephone number store 106 maps all of Joe's client devices to Joe's userID, as follows:
5105553536->userID-JOE

A database table domain/telephone number store 106 associates Joe's userID with all his domains, as follows:
userID-JOE->WORK_XYZ_CO
userID-JOE->FAMILY_SMITH

A database table domain/telephone number store 106 defines the telephone numbers belonging to each domain. Telephone numbers are stored in reverse order. For example:
domainID-WORK_XYZ_CO.6353555015—Joe (Entry for 510-555-3536—the client device can be an implicit member of this domain)
domainID-WORK_XYZ_CO.6349555015—Steve
domainID-WORK_XYZ_CO.6654555015—Helen
domainID-WORK_XYZ_CO.7253555015—Fred
domainID-WORK_XYZ_CO.5350555015—Linda
domainID-FAMILY_SMITH.5207555056—Frank
domainID-FAMILY_SMITH.6307555056—Sally

To call Fred, Joe can dial any of: 7, 27, 527, 3527, 53527, 553527, 5553527, 05553527, 105553527, or 5105553527.

To call Sally, Joe can dial 6 if the FAMILY_SMITH domain is ranked higher than the WORK_XYZ_CO, or he can dial 036 if the ranking is reversed or equal. If the ranking is equal and Joe dials 36, the following calling options are displayed for Joe to choose between:
Sally 650-555-7036 (Family)
Steve 510-555-9436 (Work)

For most companies, four digits are sufficient to address any employee; for most families, two digits are sufficient to address a family member. In one embodiment, the system can be configured to require a fixed number of digits for each of a user's domains; for example, entering four digits causes the work domain to be searched (or searched first), while entering two digits causes the family domain to be searched (or searched first). The user may also explicitly select the domain(s) to search when entering the abbreviated address digit string; this overrides the default domain search algorithm in use by the system for that user.

To maintain emergency service telephone numbers (911) and other special carrier supplied short-number services, in one embodiment some telephone numbers bypass the abbreviated dialing system. This can be configured by the wireless carrier, or by the manufacturer or client device 100, or by the user.

Domain Configuration and Population

Domains can be arranged, organized, and populated according to any desired scheme. Some domains are easy to identify and are defined with minimal or no configuration. For example a FAMILY domain can be created for a family subscribing to a wireless carrier's “family plan” with multiple mobile phones. This domain is automatically populated with the telephone numbers of all mobile phone users on the plan. Additional, non-plan family telephone numbers can be added via user configuration.

A company domain is another example of a domain requiring minimal configuration. Client devices which are not already in the domain, can be added to the domain via user configuration. A client device with a telephone number that is in the domain can be associated to the domain by default.

Using dialed number lists or received number lists as domains presents a problem when a low frequency (non-interesting) telephone number has final digit(s) matching telephone numbers of interest (in the same or other domains). This problem can be mitigated by giving these domains a lower ranking and not displaying matches within them if there is a match or matches in a higher ranking domain.

It is also possible to search domains using wild-cards (* or #) or other search criteria.

User Interface

Existing client devices such as cell phones have sufficient input/output components to present information to the user and accept input from the user for querying. Such components include, for example, screens, keypads, keyboards, roller switches, rocker switches, dials, graphical user interfaces, five-way switches, knobs, and the like. In addition, output can be provided via voice prompting, and input can be received via voice recognition or any other applicable technique.

Related Functions

Call Re-Vectoring

In one embodiment, the system of the present invention can be used to re-vector a callee's calls. A callee (a party that receives telephone calls) configures the system to send calls that address the callee (in abbreviated or full form) to an alternate telephone number or other delivery address such as an e-mail enabled voicemail platform. This re-vectoring can be a function of the telephone number of the caller, the number dialed by the caller, the time of day, the explicit or implicit callee desires, presence information of the caller, presence information of the callee, and other factors. This functionality is related to Origin-switch Dynamic Number Portability variously described in the following related U.S. patent applications, the disclosures of which are incorporated herein by reference:

U.S. patent application Ser. No. 11/060,232 for CALL MANAGEMENT, filed Feb. 16, 2005 (attorney docket number 9193);

U.S. patent application Ser. No. 11/060,642 for DYNAMICALLY ROUTING TELEPHONE CALLS, filed Feb. 16, 2005 (attorney docket number 10031); and

U.S. patent application Ser. No. 11/060,085 for INFORMING CALLER OF CALLEE ACTIVITY MODE, filed Feb. 16, 2005 (attorney docket number 10032).

For this re-vectoring to be independent of caller, in one embodiment a network component dips the system's database for each call destined to the dialed device. In one embodiment, the system's database is the single source of re-vectoring information. When the callee makes a configuration change, that change is immediately available to the system for routing subsequent calls. In another embodiment, configuration information in the system's central database is propagated out to other network elements (for example, a mobile switching center, or as far out as the client itself), where the re-vectoring is performed.

Network Selection

In one embodiment, the system of the present invention can also specify the network the call should be placed on. For example, when a user enters an abbreviated address, or full telephone number, the system can reply with the full telephone number (or re-vectored telephone number) and the network or technology (PSTN, VoIP, Skype) to use to best route the call to the callee. The best route may be determined by cost, network load, security, fidelity, or other factors.

Short-Cut Dialing Based on Past Call Habits

A short-cut dialing list can be displayed to the user based on a user's past calling habits. This list can be constructed by the dialing device, with or without data from a centralized service. The short-cut list presented to the user by the device can dynamically change and be based on time-of-day, location, past calling habits, etc. For example, if a user calls home every day when leaving the office between 6:30 pm and 7:30 pm, their home number would be on the top of the list at that time. If the same user has a recurring teleconference every Friday at 9 am, that user (and all of the other users who participate in the teleconference) would have the required call-in telephone number for that meeting at the top of the short-cut list starting a few minutes before 9 am on Fridays.

Remote Access to Abbreviated Dialing Functions

In one embodiment, the present invention allows a user to access abbreviated dialing functions even when not calling from his or her usual calling device 100. Such a capability can be useful, for example, if the user has lost his or her cell phone or does not have it with him or her. In one embodiment, such functionality can be enabled, for example, by allowing the user to call the service from any phone and enter the telephone number of the domain-associated device, a pass-code (for security), and the abbreviated address they are interested in calling. The service would play-back verbally, or dial the resulting telephone number as though the user had called from his or her usual calling device 100.

The present invention thus provides a mechanism by which users need only dial a portion of the telephone number they wish to call. Based on known information about the caller and associated domains, the system determines which telephone number is desired, and causes that number to be dialed. In this manner, abbreviated dialing is efficiently implemented, and the system also trains a caller to enter (and memorize) the minimum number of digits necessary for call initiation to callees that are frequently called.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method for abbreviated dialing of a telephone number, comprising:
receiving caller input comprising an abbreviated dial string;
determining a telephone number from the abbreviated dial string; and
initiating a call to the determined telephone number.

2. The method of claim 1, wherein determining the telephone number comprises selecting a telephone number having a sequence of digits that matches the abbreviated dial string.

3. The method of claim 1, wherein determining the telephone number comprises selecting a telephone number having an end sequence of digits that matches the abbreviated dial string.

4. The method of claim 1, wherein determining the telephone number comprises:
determining at least one domain; and
selecting a telephone number belonging to at least one determined domain and having a sequence of digits that matches the abbreviated dial string.

5. The method of claim 4, wherein determining at least one domain comprises determining a domain to which the caller belongs.

6. The method of claim 4, wherein domain membership is automatically determined.

7. The method of claim 4, wherein domain membership is user-configured.

8. The method of claim 4, further comprising selecting a calling network responsive to domain membership.

9. The method of claim 4, wherein:
receiving caller input comprises receiving caller input via a calling device; and
determining at least one domain comprises determining a domain to which the calling device belongs.

10. The method of claim 1, wherein determining the telephone number comprises:
determining at least two domains;
determining at least two telephone numbers, each belonging to at least one determined domain and having a sequence of digits that matches the abbreviated dial string; and
selecting one of the determined telephone numbers based on domain priority.

11. The method of claim 10, wherein domain priority is predefined.

12. The method of claim 10, wherein domain priority is variable depending on at least one of time of day, day of week, date, location, and user configuration.

13. The method of claim 1, wherein determining the telephone number comprises:
determining at least two telephone numbers, each having a sequence of digits that matches the abbreviated dial string;
prompting the caller to select among the determined telephone numbers; and
receiving caller selection of a telephone number.

14. The method of claim 1, wherein determining the telephone number comprises:
determining at least two telephone numbers, each having a sequence of digits that matches the abbreviated dial string; and
selecting one of the telephone numbers based on past dialing behavior.

15. The method of claim 1, wherein determining the telephone number comprises:
determining at least two telephone numbers, each having a sequence of digits that matches the abbreviated dial string;
prompting the caller to enter at least one additional digit;
responsive to receiving at least one additional digit, determining a telephone number from the abbreviated dial string.

16. The method of claim 1, wherein determining the telephone number comprises:
retrieving from a data store at least one telephone number having a sequence of digits that matches the abbreviated dial string.

17. The method of claim 16, wherein receiving caller input is performed at a calling device, and wherein the data store is located remotely with respect to the calling device.

18. The method of claim 17, wherein determining the telephone number comprises, at the calling device:
generating an abbreviated dialing query;
transmitting the abbreviated dialing query to a resource capable of accessing the data store;
receiving, from the resource, a response including the determined telephone number.

19. The method of claim 17, wherein determining the telephone number comprises, at a wireless carrier voice switch:
generating an abbreviated dialing query;
transmitting the abbreviated dialing query to a resource capable of accessing the data store;
receiving, from the resource, a response including the determined telephone number.

20. The method of claim 16, wherein receiving caller input is performed at a calling device, and wherein the data store is located at the calling device.

21. The method of claim 1, wherein receiving caller input is performed at a calling device.

22. The method of claim 21, wherein the calling device comprises at least one selected from the group consisting of a wireless telephone, a wired telephone, an Internet-connected telephone, a personal digital assistant, a laptop computer, a handheld computer, a desktop computer, a payphone, and a kiosk.

23. The method of claim 1, wherein determining a telephone number from the abbreviated dial string comprises retrieving at least one candidate telephone from a set of candidate telephone numbers, wherein the set of candidate telephone numbers is determined based on at least one characteristic of the caller.

24. A computer program product for abbreviated dialing of a telephone number, comprising:
a computer-readable medium; and
computer program code, encoded on the medium, for:
receiving caller input comprising an abbreviated dial string;
determining a telephone number from the abbreviated dial string; and
initiating a call to the determined telephone number.

25. The computer program product of claim 24, wherein the computer program code for determining the telephone number comprises computer program code for selecting a telephone number having a sequence of digits that matches the abbreviated dial string.

26. The computer program product of claim 24, wherein the computer program code for determining the telephone number comprises computer program code for selecting a telephone number having an end sequence of digits that matches the abbreviated dial string.

27. A system for abbreviated dialing of a telephone number, comprising:
a telephone number store, for storing associations for resolving abbreviated dialing queries;
an abbreviated dialing interface server, for receiving an abbreviated dialing query comprising an abbreviated dial string, and for determining a telephone number from the abbreviated dial string by reference to the telephone number store; and
a communication mechanism for transmitting the determined telephone number to a call initiator for initiating a call to the determined telephone number.

28. The system of claim 27, wherein the abbreviated dialing interface server determines the telephone number by selecting a telephone number having a sequence of digits that matches the abbreviated dial string.

29. The system of claim 27, wherein the abbreviated dialing interface server determines the telephone number by selecting a telephone number having an end sequence of digits that matches the abbreviated dial string.

30. The system of claim 27, wherein the abbreviated dialing interface server determines the telephone number by:
determining at least one domain; and
selecting a telephone number belonging to at least one determined domain and having a sequence of digits that matches the abbreviated dial string.

31. The system of claim 30, wherein the abbreviated dialing interface server determines at least one domain by determining a domain to which the caller belongs.

32. The system of claim 30, wherein domain membership is automatically determined.

33. The system of claim 30, wherein domain membership is user-configured.

34. The system of claim 30, further comprising a switch for selecting a calling network responsive to domain membership.

35. The system of claim 30, wherein:
the abbreviated dialing interface server receives caller input originating at a calling device; and
the abbreviated dialing interface server determines at least one domain by determining a domain to which the calling device belongs.

36. The system of claim 27, wherein the abbreviated dialing interface server determines the telephone number by:
determining at least two domains;
determining at least two telephone numbers, each belonging to at least one determined domain and having a sequence of digits that matches the abbreviated dial string; and
selecting one of the determined telephone numbers based on domain priority.

37. The system of claim 36, wherein domain priority is predefined.

38. The system of claim 36, wherein domain priority is variable depending on at least one of time of day, day of week, date, location, and user configuration.

39. The system of claim 27, wherein the abbreviated dialing interface server determines the telephone number by:
determining at least two telephone numbers, each having a sequence of digits that matches the abbreviated dial string;
transmitting, to a calling device, an instruction to prompt the caller to select among the determined telephone numbers; and
receiving caller selection of a telephone number.

40. The system of claim 27, wherein the abbreviated dialing interface server determines the telephone number by:
determining at least two telephone numbers, each having a sequence of digits that matches the abbreviated dial string; and
selecting one of the telephone numbers based on past dialing behavior.

41. The system of claim 27, wherein the abbreviated dialing interface server determines the telephone number by:
determining at least two telephone numbers, each having a sequence of digits that matches the abbreviated dial string;
transmitting, to a calling device, an instruction to prompt the caller to enter at least one additional digit;
responsive to receiving at least one additional digit, determining a telephone number from the abbreviated dial string.

42. The system of claim 27, wherein abbreviated dialing interface server determines the telephone number by:
retrieving from the telephone number store at least one telephone number having a sequence of digits that matches the abbreviated dial string.

43. The system of claim 42, wherein caller input originates at a calling device, and wherein the telephone number store is located remotely with respect to the calling device.

44. The system of claim 43, wherein the calling device comprises at least one selected from the group consisting of a wireless telephone, a wired telephone, an Internet-connected telephone, a personal digital assistant, a laptop computer, a handheld computer, a desktop computer, a payphone, and a kiosk.

45. The system of claim 27, wherein the abbreviated dialing interface server determines a telephone number from the abbreviated dial string by retrieving at least one candidate telephone from a set of candidate telephone numbers, wherein the set of candidate telephone numbers is determined based on at least one characteristic of the caller.
